(19) United States
(12) Patent Application Publication
(10) Pub. No.: US 2004/0020356 A1
(43) Pub. Date: Feb. 5, 2004

(54) Simulation of a system a mechanical subsystem and a hydraulic subsystem

(76) Inventor: Harri Ojanen, Helsinki (FI)

Correspondence Address: YOUNG & THOMPSON, 745 SOUTH 23RD STREET 2ND FLOOR, ARLINGTON, VA, 22202

(21) Appl. No.: 10/398,174

(22) PCT Filed: Oct. 17, 2001
(86) PCT No.: PCT/FI01/00904

(30) Foreign Application Priority Data
Oct. 17, 2000 (FI) 20002296

(51) Int. Cl. F15B 13/16

(52) U.S. Cl. 91/361

(57) ABSTRACT

A method (90) for simulating a system having a mechanical subsystem and a hydraulic subsystem is presented. The method comprises the steps of: describing (92) the mechanical subsystem and the effect of the hydraulic subsystem thereupon by integrating a first differential equation system of an n-dimensional first variable using a first numerical method, resulting in a sequence of values for the first variable; and describing (94) the hydraulic subsystem and the effect of the mechanical subsystem thereupon by integrating a second differential equation system of an m-dimensional second variable using a second numerical method, resulting in a sequence of values for the second variable. A corresponding arrangement having a first integrator (1) and a second integrator (4) is also presented.

### A. TECHNICAL FIELD OF THE INVENTION

The invention relates in general to simulation of systems having a mechanical subsystem and a hydraulic subsystem. An example of such a system is a hydraulically driven mechanical system. Advantageously, the invention relates to real-time simulation of such systems.

### B. BACKGROUND OF THE INVENTION

Hydraulic machines, which are commonly used in areas such as construction, mining, excavation and forestry, are examples of hydraulically driven mechanical systems. Simulation of hydraulically driven mechanical systems is needed, for example, in designing new machines by using simulation models (virtual prototypes) for at least some subsystems of the machine in place of actual prototypes, in training simulators, or in finding values for control parameters of hydraulically driven mechanical systems.

Simulation methods relating to hydraulically driven mechanical systems are in general numerical methods, where differential equation models describing a hydraulically driven mechanical system are constructed and then the differential equation models are numerically solved for consecutive time steps.

By definition in real-time simulation the simulator must respond to external events or data within a predefined deadline. Real-time simulation is feasible, if the computing time required to numerically solve the differential equation models for a time step is shorter than the time step itself. However, typically the system has to perform also other tasks, such as visualization and communication. In such systems the required computing time should be significantly less than the time step. Real-time simulation is needed, for example, in virtual prototypes when some parts of the machine are simulated and others are actual physical prototypes and such systems are connected together, and in training simulators, where a user should obtain immediate feedback on the control actions he carries out.

Currently, real-time simulation of hydraulically driven mechanical systems is in many cases problematic. In many cases the differential equation models describing the hydraulically driven mechanical system cannot be numerically solved in such times that real-time simulation is feasible. On the other hand, if the model describing the hydraulically driven mechanical system is simplified so that real-time simulation is possible, typically some important features of the hydraulically driven mechanical system are lost.

Numerical methods for the simulation of hydraulically actuated mechanical systems are usually based on deriving differential equation models for the system. These equations form a non-linear system of differential equations. In order to take into account the interactions in the hydraulic circuit, the mechanical system, and between the hydraulic and mechanical components, all important aspects of the machine are introduced into the same differential equation model. This results in a relatively large non-linear system of equations, with starting from between ten and twenty equations even for simple models.

Numerical methods for solving differential equations are discussed, for example, in references [2] and [7], and they comprise explicit methods, which involve only function evaluations of the differential equation during a time step; implicit methods, which involve the solution of a (generally non-linear) system of equations during a time step; and semi-implicit methods, which involve the solution of a linear system of equations during each time step.

Some differential equations exhibit behavior that has been termed (numerical) stifffness. The fundamental idea is that the maximum ratio between the real parts of those eigenvalues of the Jacobian with a negative real part is very large, so that the range of typical frequencies arising from transients inherent in the system is very large. Some examples of stiff systems are springs with a very large spring coefficient and strong damping, and hydraulic systems, where the stiffness arises from the near incompressibility of fluids.

The numerical solution of stiff differential equations is discussed, for example, in reference [7], and it usually requires special methods. Explicit methods do not work well, if at all, for stiff systems: to keep the method numerically stable in general the step-size has to be inversely proportional to the absolute value of the largest frequency in the system. For hydraulics simulation this may result in step-sizes even of the order of magnitude 10⁻⁶ s, which is beyond practical. In this document we divide stiff systems into moderately and strongly stiff based on the relative difficulty of solving the system. In practice most purely mechanical systems are either not stiff or only moderately so (for example, the springs that are typically used are not exceedingly stiff). Explicit methods could in principle be used for such systems, even though relatively small time-steps are needed, but real-time simulation would not be possible with an explicit method. However, for some systems, such as hydraulics, the time-step requirement is so severe for explicit methods that implicit and semi-implicit methods are the only option. We call such systems strongly stiff.

Due to the special nature of hydraulic systems (arising from the near incompressibility of hydraulic fluids) the differential equations describing hydraulic systems are numerically strongly stiff, hence the numerical solution of the equations has to be done using an implicit differential equation solver. Such methods need the solution of a non-linear system of equations during each time step of the simulation. Since the number of equations is already relatively large, computing each time step is a fairly computationally intensive process. For example, references [11] and [13] describe approaches where an implicit Runge-Kutta method is used for solving a system of equations describing a hydraulic driven multibody system (mechanical subsystem) and hydraulic circuits (hydraulic subsystem), respectively.

A hydraulically actuated mechanical system, for example, can be modeled using a differential equation system of the form

\dot{x}=H(x, t), (1)

where the vector x contains position and velocity variables for the mechanical system and pressures and possibly other quantities (such as flows) related to the hydraulic system. The function H depends not only on the details of the two systems but also on the modeling formalisms that are used. This system of differential equations is then solved numerically.

The general form for a numerical integrator (that is, a method for computing numerical values for a set of variables from a system of ordinary differential equations those variables satisfy) for Equation (1) is

xₖ₊₁=xₖ+I(xₖ, xₖ₊₁; H),

where xₖ is an approximation to x(hk) and h is the time step. The form of the functional I depends on the integrator: In an explicit integrator I(xₖ,xₖ₊₁;H) is independent of xₖ₊₁, hence the new state can be computed directly. In implicit methods I depends directly on x₊₁, hence the computation of the new state requires the solution of a system of equations. In general this system is non-linear. If I depends on x₊₁ linearly, the method is called semi-implicit.

Linearized models have also been used to some degree, especially for selecting parameters for control systems. Because of the linearization the domain of validity of these models is limited, i.e., they cannot be used for a general-purpose simulation of the coupled hydraulic and mechanical system.

Simulation methods that are not based on differential equation models have been used, e.g., in some forestry machine training simulators. In these systems the goal, however, is to give the student a realistic feeling of the overall operation of the machine. In particular, the behavior of the individual components in the machine are not modeled or simulated accurately. Reference [5] proposes another approach that could be used to develop a training simulator for a forestry machine, and would include the simulation of mechanical and hydraulic systems. In order to make the differential equations less stiff and hence easier to solve, hydraulic models are simplified and some of the parameters in the valves are relaxed. The implementation results presented in [5] suggest that real-time simulation is not possible using this approach. Even with the possible improvements mentioned by the authors their approach is not fast enough for accurate simulation of realistic systems in real-time.

The most important problem associated with the current approaches on simulation of hydraulically driven mechanical systems is the fact that because the simulation is too slow for real-time operation it is not possible to connect it to hardware such as an actual control unit. That is, hardware-in-the-loop simulations are not possible if realistic models for the hydraulic components are needed. It is therefore not possible to connect simulated subsystems of a machine with actual physical subsystems, or to build, for example, a training simulator, where the system is accurately modeled.

### C. SUMMARY OF THE INVENTION

An object of the invention is to present flexible and efficient simulation of a system having a mechanical subsystem and a hydraulic subsystem. Furthermore, an object of the invention is to present such simulation of such systems which allows modeling of the hydraulic components without extensive simplifications. Advantageously, a further object of the invention is to present such simulation of a system having a mechanical subsystem and a hydraulic subsystem which allows real-time operation and hardware-in-the-loop simulations.

These and further objects of the invention are achieved by using a partitioned integrator, which comprises separate integrators: a first integrator for integrating the first differential equation system relating to a mechanical subsystem of the system and effect of the hydraulic subsystem thereupon, this effect being taken into account using actuator forces and said first integrator employing a first numerical method; and a second integrator for integrating a second differential equation system relating to a hydraulic subsystem and effect of the mechanical subsystem thereupon, said second integrator employing a second numerical method.

A method according to the invention is characterized by that which is specified in the characterizing portion of the appended independent method claim.

A computer program according to the invention is characterized by that which is specified in the characterizing portion of the appended independent claim directed to a computer program.

A simulation arrangement according to the invention is characterized by that which is specified in the characterizing portion of the appended independent arrangement claim.

The accompanying dependent claims present some preferred embodiments of the invention.

We describe a new approach to the simulation of systems having a mechanical subsystem and a hydraulic subsystem, for example to the simulation of hydraulically driven mechanical systems. The idea is to use a partitioned integrator which preferably has specialized and optimized modules separately for hydraulics and mechanics. In addition to allowing optimal selection of numerical integration methods, the division of a large differential equation system of an n+m-dimensional variable into a first differential system of an n-dimensional variable and a second differential system of an m-dimensional variable provides typically a faster simulation method, as the computation time required for the solution of a differential equation system typically grows with the third power of the dimension of the differential equation system.

There exist prior art simulation methods, where a differential equation system describing a physical system is divided into a number of differential equation systems, which are solved separately. As an example, it is possible that the hydraulic subsystem is treated with a special method or software suitable for hydraulic simulation and the mechanical subsystem is treated with another specialized method or software. These prior art simulation methods typically require repeated trials for obtaining a consistent solution for the whole system for a simulation time step. In other words, these prior art simulation method are typically iterative and, therefore, typically not suitable for real-time simulation.

According to the invention, the system to be simulated is modeled so that the effect of the hydraulic subsystem on the mechanical subsystem is taken into account using actuator forces. The interactions between different hydraulic cylinders in the hydraulic subsystem are advantageously treated by using discrete simulation, which effectively decouples the differential equations that describe the hydraulic cylinders. The decoupling allows the use of a fast and robust solver for the hydraulic subsystem. A current state for the hydraulic subsystem is determined using a previous state of the mechanical subsystem and, in the presence of control signals; taking into account possible changes in these control signals. Actuator forces relating to the current state of the hydraulic subsystem are computed, and a current state for the mechanical subsystem is determined using the current state of the hydraulic subsystem and the current actuator forces. There is no need to perform iterations to fit the solutions of the hydraulic and mechanical systems together.

Furthermore, by adding a discrete event simulation for taking into account the interactions in the hydraulic circuit it is possible to uncouple the second differential equation system relating to the hydraulic subsystem. Hence, after an event handling stage at the beginning of each time step the hydraulic components may be integrated separately from the rest of the system and from each other. The hydraulic component integrator (the second integrator) is in preferred embodiments of the invention, which are discussed below, very fast and robust due to its simplicity. It preferably also has a built-in low pass filter (L-stability) which makes it possible to automatically disregard high frequency transients in the hydraulic system: after all, these are damped by the connections to the mechanical system.

A mechanical subsystem of physical system to be simulated has a number of bodies (that is, at least one body) and, as the number of bodies is typically far more than one in realistic physical systems, a number of joints connecting the bodies, and the hydraulic subsystem has a number of hydraulic actuators (that is, at least one actuator). As the invention relates to simulation of such physical systems, where in the simulation the subsystems are modeled as described below, the exact number of bodies, joints or actuators is not a restrictive feature for the invention.

### D. BRIEF DESCRIPTION OF THE FIGURES

The invention will now be described more in detail with reference to embodiments and preferred embodiments by the way of example and to the accompanying drawings where

FIG. 1 illustrates schematically a structure of an arrangement according to an embodiment of the invention,

FIG. 2 illustrates schematically a structure of a hydraulics sub-arrangement in an arrangement according to an embodiment of the invention,

FIG. 3 illustrates a main flow of control in an arrangement according to an embodiment of the invention,

FIG. 4 illustrates an event handling subflow in an arrangement according to an embodiment of the invention,

FIG. 5 illustrates computation of accelerations subflow in an arrangement according to an embodiment of the invention,

FIG. 6 shows an example of visualization of positional data,

FIG. 7 shows an example of visualization of hydraulics data,

FIG. 8 shows an example of a visualization of simulated mechanism in three dimensions,

FIG. 9 illustrates a flowchart of a method according to an embodiment of the invention, and

FIG. 10 illustrates part of a flowchart of a method according to a further embodiment of the invention.

### E. THE PARTITIONED INTEGRATOR

We present a partitioned integrator for the numerical solution of, for example, stiff ordinary differential equation systems that can be partitioned into moderately stiff and strongly stiff parts. The partitioned integrator may be multirate, i.e., the time steps in the first integrator and the second integrator need not be equal, and typically the first integration method is implicit and the second integration method is semi-implicit. The integrator is applied, for example, to the simulation of hydraulically driven mechanical systems.

We assume that the system that Equation (1) describes can also be modeled using differential equations in the partitioned form

$$\ddot{q} = F ( q , \dot{q} , f ( p ) ) , \\ \dot{p} = G ( p , q , \ddot{q} ) , \qquad ( 2 )$$

where q∈Rⁿ, n≧1 is the configuration of the mechanical system (e.g., generalized coordinates), pÅR^{m}, m≧1 is the vector of pressure variables from the hydraulic actuators, and f(p) is the vector of actuator forces. In a typical application of the method discussed below F yields a moderately stiff discretization and G strongly stiff, but this need not be the case. Note that contrary to Equation (1) the differential equation system (2) is autonomous, that is, the right-hand sides do not depend on time directly. Indeed, we describe in Section I how time dependent events are simulated outside of the differential equation models, hence it is sufficient to consider only autonomous systems.

In a proposed integrator the moderately stiff part \ddot{q}=F is first written as a first order ordinary differential equation

\dot{y}=\hat{F}(y, f(p)) (3)

where y∈R²ⁿ is given by

$$\begin{matrix}y = ( \begin{matrix}q \\ \dot{q}\end{matrix} ) , and & ( 4 ) \\ \hat{F} ( ( \begin{matrix}q \\ \dot{q}\end{matrix} ) , f ) = ( \begin{matrix}\dot{q} \\ F ( q , \dot{q} , f )\end{matrix} ) . & ( 5 )\end{matrix}$$

Let h₁>0 be the discretization step length. In order to discretize the first order ordinary differential equation (3) with an implicit or semi-implicit method the Jacobian matrix J of \hat{F} is needed. Analytically the matrix is defined by

$$J = \partial \hat{F} ( y , f ( {p}_{j} ) ) / \partial y {\vert}_{{y}_{t}} = [ \begin{matrix}\frac{\partial {\hat{F}}^{( 1 )} ( y , f ( {p}_{j} ( y ) ) )}{\partial {y}^{( 1 )}} {\vert}_{{y}_{t}} & ⋯ & \frac{\partial {\hat{F}}^{( 1 )} ( y , f ( {p}_{j} ( y ) ) )}{\partial {y}^{( 1 )}} {\vert}_{{y}_{t}} \\ ⋮ & ⋰ & ⋮ \\ \frac{\partial {\hat{F}}^{( 2 n )} ( y , f ( {p}_{j} ( y ) ) )}{\partial {y}^{( 1 )}} {\vert}_{{y}_{t}} & ⋯ & \frac{\partial {\hat{F}}^{( 2 n )} ( y , f ( {p}_{j} ( y ) ) )}{\partial {y}^{( 1 )}} {\vert}_{{y}_{t}}\end{matrix} ] , \qquad ( 6 )$$

where \hat{F}=(\hat{F}⁽¹⁾, . . . \hat{F}⁽²ⁿ⁾)^{T} and y=(y⁽¹⁾, . . . y⁽²ⁿ⁾)^{T}. Note that the dependence of p on q and \dot{q} is shown above explicitly. The Jacobian matrix J may alternatively be approximated by the divided differences

$${\partial {F}^{( 1 )} ( y , f ( {p}_{j} ) ) / \partial {y}_{1} \vert}_{{y}_{t}} \approx \frac{{\hat{F}}^{( 1 )} ( {y}_{i}^{( 1 )} , … , {y}_{i}^{( 2 n )} , f ( {p}_{j} ( {y}_{i}^{( 1 )} , … , {y}_{i}^{( 2 n )} ) ) ) - {\hat{F}}^{( 1 )} ( {y}_{i}^{( 1 )} - ϵ , … , {y}_{i}^{( 2 n )} , f ( {p}_{j} ( {y}_{i}^{( 1 )} - ϵ , … , {y}_{i}^{( 2 n )} ) ) )}{ϵ} , \qquad ( 7 )$$

where ε is a suitable constant such as 10⁻⁴. Note that the first n rows of the Jacobian are trivially computed from the definition of \hat{F} in Equation (5).

In one preferred embodiment of the invention, the discretization used for the ordinary differential equation \dot{y}=\hat{F} of Equation (3) is a semi-implicit W-method defined as follows: Let W∈R⁴ⁿ^{²} be defined by W=I−h₁dJ, where I is the 2n by 2n identity matrix, J is the Jacobian matrix of \hat{F} and d=1/(2+\sqrt{2}). Then the integrator is defined by

$${Wk}_{1} = \hat{F} ( {y}_{i} , f ( {p}_{j} ( {y}_{i} ) ) ) , \\ {\hat{y}}_{i} = {y}_{i} + \frac{2}{3} {h}_{1} {k}_{1} \\ {Wk}_{2} = \hat{F} ( {\hat{y}}_{i} , f ( {p}_{j} ( {\hat{y}}_{i} ) ) ) - \frac{4}{3} {h}_{1} {dJk}_{1} , \\ {y}_{i + 1} = {y}_{i} + \frac{{h}_{1}}{4} ( {k}_{1} + 3 {k}_{2} ) , \qquad ( 8 )$$

where k₁, k₂∈R²ⁿ, see [7], pp. 114-116, or [15].

The important fact about this method is that when J is the Jacobian of \hat{F} the method is L-stable (see below). It is possible to use alternatively other discretization methods for the first order differential equation of Equation (2). This discretization is the numerical integration method relating to the first integrator of the partitioned integrator according to the invention.

L-stability means the following: if the method is applied to the standard one-dimensional model equation \dot{y}=λy, the discretization results in a recursion yₖ₊₁=R(λh)yₖ, where the modal amplification function R(z) is specific to the method. A method is L-stable if |R(z)|≦1 for all z with negative real part and

$${lim}_{\vert z \vert \to ∞} R ( z ) = 0 ,$$

R(z)=0, see [7], p. 44. This implies that the method damps high frequencies very effectively.

L-stability is a desirable property for the first integrator. For this reason, and also due to their efficiency, any W-method is suitable. It is also possible to use other semi-implicit methods (Rosenbrock methods [7], pp. 102-117) within the limitations that the stability properties of each method introduces. Fully implicit methods such as Implicit Runge-Kutta methods [7], pp. 71-89, or Backward Differentiation Formulae [7], pp. 246-247, can also be used if the solution of the non-linear system is not an issue. In some applications, when the second part \dot{p}=G does not introduce stiffness into the first part \dot{y}=\hat{F}, it is also possible to use explicit integrators.

Simulation of the stiff part \dot{p}=G typically results in very high frequencies, especially if the application is into hydraulics. In practice the physical mechanical subsystem will damp the high frequencies arising from the hydraulics. Hence the part of the model \ddot{q}=F (that corresponds to the mechanical subsystem) should preferably also damp high frequencies. Using an L-stable discretization allows embedding the damping into the discretization: the high frequencies are never computed.

The stiff part \dot{p}=G of Equation (2) may be discretized, for example, with fully implicit Euler's method, which is an L-stable method, as follows. For simplicity first let h₂=₁ be the discretization step length for the part P=G; we will discuss below the case h₂<h₁, which yields a multi-rate integrator. The discretization of the second differential system in Equation (2) using implicit Euler method is given by

pⱼ₊₁=pᵢ+h₂G(pⱼ₊₁, qᵢ,\dot{q}ᵢ) (9)

In general, this can be solved with Newton's method or any of its modifications. Other implicit and semi-implicit methods can also be used in the place of Equation (9). The discretization of the ordinary differential equation \dot{p}=G is relating to the second integrator of a partitioned integrator according to the invention. A partitioned integrator, where the second integrator employs an implicit method is beneficial for the following reasons: this not only allows using a simpler and faster integrator for the mechanical subsystem of the system but also replaces the need to solve one large non-linear system of equations for the whole model with the solution of two smaller systems (whose dimensions adds up to the size of the large system). The solution of two smaller systems is faster, since the computation time required for the solution of a system of equations grows with the third power of the dimension of the system.

Newton's method and its modifications are iterative numerical methods for the approximate solution of non-linear equations. Such methods are, however, not the best possible for real-time simulation for two reasons: The most obvious difficulty is that the methods require a lot of computation due to the iterative nature of the algorithm. Another difficulty in using such methods is the requirement that in order for the iteration to converge the initial approximation has to be close to the actual solution. In the integration of differential equations the previous state is used as the initial approximation. If the state of the system does not change much during each time-step Newton's method is likely to work. However, if the changes in the state, are large, it may be the case that an iterative method does not converge, that is, it cannot solve for the new state. This puts an upper limit on how large a step-size can be used, and hence a limit on the speed of the simulation.

Therefore, a further goal is to derive a very fast and robust way of solving the differential equation system \dot{p}=G: the differential equations are uncoupled by using discrete event simulation at the beginning of each time step to take into account the interactions between the components. Then an analytic solution can be derived for Equation (9). The details are described in Section G below.

Note that the discretization (9) for \dot{p}=G yields a method that not only is L-stable but also has stiff decay [2], pp. 58-59. Hence the discretization works for strongly stiff equations such as those arising from hydraulics models. More specifically, it is possible to use a long step length so that the high frequency components of p are never computed.

In order to introduce a multirate method according to a further preferred embodiment of the invention, we let h₂=h₁/r for some r∈N be the discretization step length for the part \dot{p}=G. The following method can then be used for each time-step on the coarser scale:

Compute the Jacobian either by using an analytic formula or by the divided differences according to Equation (7) using the current state of the mechanical and hydraulic systems.

Then integrate the slower system (3) with time step A; using the discretization given in Equation (8) and the current values of the slower system.

Integrate the faster system \dot{p}=G with time step h₂ by using Equation (9) until the faster system is stepped for a total time of h₁. The values of q and \dot{q} that are needed during the computation of p are interpolated between the previous state of the slower system (3) and the new state computed above.

F. Mechanical Subsystem

Consider, for example, a hydraulically driven mechanical system having a certain number of hydraulic actuators. The hydraulic actuators involve hydraulic cylinders, which are coupled to a number of tanks and to a number of pumps with a number of control valves. To obtain equations of motion of the mechanical subsystem of said hydraulically driven mechanical system any generalized or reduced order coordinate method may be used, which gives the vector F in the ordinary differential equation system

\ddot{q}=F(q,\dot{q},f(p)),

and where f(p) is the actuator force vector from the hydraulic cylinders. This ordinary differential equation is discretized with the W-method of the previous section.

A flexible choice for computing F is the Featherstone algorithm [4], which computes the accelerations in each generalized coordinate given the values of the coordinates and their first derivatives together with a description of the mechanical system. This algorithm is well described in the literature. The Featherstone algorithm is one example of recursive dynamics algorithms, any other such method may alternatively be used.

The equations for F may alternatively be derived case-by-case using other standard methods, e.g., by using Lagrangian dynamics directly [1], pp. 75-148.

A further approach is to use redundant coordinates (e.g., Cartesian coordinates), where at least some of the physical bodies in the system are described by more coordinates than in a reduced order coordinate representation (but with at most either three coordinates for planar systems or six coordinates for motion in three dimensions). Such approaches are also well documented in the literature, see, e.g., [14], pp. 21-38, or [7], pp. 530-542. For constrained systems they lead to differential-algebraic equations instead of ordinary differential equations: the ordinary differential equation \ddot{q}=F(q, \dot{q}, f(p)) is replaced by the more general equation

M(q)\ddot{q}=F(q, \dot{q}, f(p)), (10)

where the square matrix M(q) is rank deficient. That is, it is not possible to solve for all components of the acceleration vector \ddot{q}, since, in effect, there are also algebraic equations present in Equation (10) in addition to differential equations. The standard approach in modeling with redundant coordinates is to use the algebraic equations to model the joints or constraints between the physical bodies in the system, and to use the differential equations to model the dynamics of the bodies.

Implicit numerical methods for the solution of Equation (10) are presented in [7], pp. 481-505, and semi-implicit methods in [7], pp. 407-425, and in [10]. Again, the semi-implicit methods are preferable due to their better efficiency when compared with implicit methods.

G. Hydraulic Component Simulation

For a hydraulic actuator a standard modified flow formula and cylinder model may be used: the flow formula is then

$$Q = \{ \begin{matrix}ac \sqrt{Δ p ,} & Δ p > {p}_{tr} , \\ \frac{ac}{2 \sqrt{{P}_{tr}}} ( 3 Δ p - \frac{Δ {p}^{2}}{{p}_{tr}} ) , & Δ p \leq {p}_{tr} ,\end{matrix} \qquad ( 11 )$$

where

Q is the flow rate through the valve orifice,

a is the relative opening of the valve with the following conventions: a=0 means the valve is closed; a>0 means the valve is connected to the hydraulic source (pump) with pressure pₛ, with maximum valve opening corresponding to a=1; a<0 means the valve is connected to the tank with pressure pᵣ with maximum valve opening corresponding to a=−1,

c is the product of the discharge coefficient and the maximum flow cross section area,

Δp is the pressure differential across the valve orifice, and

pₜᵣ is the transition pressure for the valve (when the flow changes from laminar to turbulent) [3].

The dynamics of the pressure in one chamber of a cylinder is typically modeled with the differential equation

$$\dot{p} = \frac{B}{Az + {V}_{0}} ( Q - A \dot{z} ) \qquad ( 12 )$$

where

z is the displacement of the shaft and \dot{z} the velocity of the shaft, and they are typically obtained from q and \dot{q} of a previously calculated state of the mechanical subsystem,

B is the bulk modulus of the hydraulic oil,

A is the area of the piston inside the chamber of the cylinder, and

V₀ is the combined dead volume of the cylinder chamber and the valve.

In a further preferred embodiment of the invention, the implicit part of the integrator from Equation (9) now yields analytic expressions for the discretized pressure. The formulae given below are obtained by using Equations (9), (11), and (12). If a different integrator or other models for the valve orifice and pressure are used, different although similar formulae are obtained.

In order to cover both the cases of flow from source (a>0) and flow to tank (a<0), let

$${p}_{ref} = \{ \begin{matrix}{p}_{s} , & a \geq 0 , \\ {p}_{T} , & a < 0 ,\end{matrix} \qquad ( 13 )$$

where p_{S} and p_{T} are the source and tank pressures, and Δp=p_{ref}−pⱼ. Consider the following cases:

If sgn(a)Δp≧pₜᵣ we have

$${p}_{j + 1} = {p}_{j} + \frac{{h}_{2} {γ}_{3}}{2} ( - sgn ( {γ}_{1} ) {h}_{2} {γ}_{1}^{2} {γ}_{3} - 2 {γ}_{4} + {γ}_{1} \sqrt{{D}_{1}} ) , \\ {D}_{1} = 4 \vert Δ p \vert + {h}_{2} {γ}_{3} ( {h}_{2} {γ}_{1}^{2} {γ}_{3} + 4 sgn ( {γ}_{1} ) {γ}_{4} ) , \\ {γ}_{1} = a c , \\ {γ}_{2} = \frac{a c}{2 \sqrt{{p}_{tr}}} , \\ {γ}_{3} = \frac{B}{Az + {V}_{0}} , \\ {γ}_{4} = A \dot{z} . \qquad ( 14 )$$

For 0<sgn(a)Δp<pₜᵣ we have

$${p}_{j + 1} = {p}_{s} - \frac{3}{2} sgn ( {γ}_{2} ) {p}_{tr} + \frac{sgn ( {γ}_{2} ) \sqrt{{D}_{2}} - {p}_{tr}}{2 {h}_{2} {γ}_{2} {γ}_{3}} , \\ {D}_{2} = {p}_{tr} ( {{p}_{tr} ( 1 + 3 {h}_{2} \vert {γ}_{2} \vert {γ}_{3} )}^{2} - 4 {h}_{2} {γ}_{2} {γ}_{3} ( Δ p + {h}_{2} {γ}_{3} {γ}_{4} ) ) , \qquad ( 15 )$$

where γ₂, γ₃, and γ₄ are as above. The special case γ₂=0 is treated separately by

pⱼ₊₁=pₛ−h₂γ₃γ₄. (16)

Finally, for sgn(a)Δp<0 we let pⱼ₊₁=pⱼ. The justification for this comes from an analysis of hydraulic circuits, not just the cylinder alone: Consider, e.g., the case a>0. Then sgn(a)Δp<0 implies that the pressure in the cylinder is higher than the source pressure. Typical hydraulic circuits are built so that fluid will not flow from a cylinder to the source, hence we let pⱼ₊₁=pⱼ.

For a hydraulic cylinder with two chambers let superscripts A and B denote the quantities relating to each chamber. The pressure differential equation with the discretization described above is used to calculate the pressures pⱼ^{A} and pⱼ^{B} in each chamber.

The force exerted by cylinder number l during time step j is then obtained as

f _{cyclinder,j}^{(l)}=pⱼ^{A}A^{A}−pⱼ^{B}A^{B}, (17)

note that the areas satisfy A^{A}>A^{B}.

There are several possibilities for the relationship between the relative valve openings for each chamber. E.g.:

a^{A}=−a^{B}: if one chamber is connected to the source, the other chamber is connected to the tank.

−1≦a^{A}≦1, a^{B}=−1: chamber A is used to extend the actuator. Since in this case chamber B is always connected to the tank, gravity or some other external force is used for pushing the piston back in.

H. Motion Limits

Motion limits for the hydraulic actuators can be added to the model as pairs of very stiff springs and dampers. Let |ξ| be the amount of overshoot with the sign of ξ taken as positive below the lower limit and negative above the upper (and ξ=0 between the limits). Then the force produced by a single motion limiter is

fₗᵢₘᵢₜ=kξ−a\dot{q}, (18)

where k is the spring coefficient and a is the damper coefficient. Typical values for these constants are of the order k=10⁷ and a=10⁵. The semi-implicit integrator of Equation (8) is easily able to handle the required large spring and damper forces.

The combined force vector, f(p) in Equation (2), at time step j is then given by fⱼ=(fⱼ^{(l)}, . . . , fⱼ^{(m)}), where

$${f}_{j}^{( l )} = {f}_{cylinder , j}^{( l )} + {f}_{limit , j}^{l} . \qquad ( 19 )$$

I. Hydraulic Subsystem Simulation

The dynamics of the couplings in the hydraulic circuit can be taken into account by using discrete event simulation, as opposed to differential equation models of the whole circuit. The discrete events are handled at the beginning of each integration time step.

If each cylinder has a dedicated pump, the methods of Section G can be applied as described.

If a set of cylinders has a common pump, the effects of opening several valves at the same time can be simulated using several different approaches (with different levels of complexity and accuracy). Which method is used also depends on the design of the particular hydraulic circuit.

The flow rates corresponding to different hydraulic actuators can be computed, for example, from Equation (11). If the total flow rate required by the actuators is higher than the maximum the pump can supply, for example one of the following approaches can be used, depending on the design of the circuit:

Let Qₘₐₓ be the maximum flow rate sustained by a source connected to a set of hydraulic actuators. Suppose the flow rates through each valve orifice of these actuators are arranged in decreasing order Qₖ_{₁}≧Qₖ_{₁}≧ . . . ≧Qₖ_{₂ₙ}.

Let the actual flow rate Qₖ_{ᵣ}^{a} that will go through orifice kᵣ be

$${Q}_{{k}_{r}}^{a} = min \{ {Q}_{{k}_{r}} , max \{ {Q}_{max} - {\sum }_{s < r}^{} {Q}_{{k}_{s}} \} \} . \qquad ( 20 )$$

Then

$${\sum }_{k}^{} {Q}_{k}^{a} \leq {Q}_{max} ,$$

but Qₖ^{a} may be zero even if Qₖ>0, i.e., the source flow rate was not sufficient for all actuators.

$$\begin{matrix}\cdot Let {Q}_{required} = {\sum }_{k}^{} {Q}_{k} , and & \\ {Q}_{k}^{a} = \frac{{Q}_{max}}{{Q}_{required}} {Q}_{k} . & ( 21 )\end{matrix}$$

Then

$${\sum }_{k}^{} {Q}_{k}^{a} = {Q}_{max}$$

and Qₖ^{a}>0 if Qₖ>0. If the source flow rate is not sufficient then Qₖ^{a}<Qₖ for all actuators for which Qₖ>0.

Depending on the design of the hydraulic circuit, there may be other rules: e.g., the circuit may be designed in such a way that the actuators receive fluid in a certain order. If the flow rate from the source is not large enough, actuators later in the chain do not receive any flow. This is easily accomplished in our model by setting the appropriate flow rates Qₖ at the corresponding orifice to zero.

More complicated methods can be used to take into account the dynamics in the circuit. Full-blown coupled ordinary differential equation models are not practical, if the simulation is to be real-time. For instance, table lookup methods as described in [8] are still practical, however.

In any of the above cases, if Qₖ^{a}<Qₖ the formulae of the previous section for computing the next value of the pressure pⱼ₊₁ are typically replaced by the simpler formula

pⱼ₊₁=pⱼ+hγ₃(Qₖ^{a}−γ₄) (22)

for the chamber corresponding to orifice k.

J. Simulation arrangement and Simulation Software

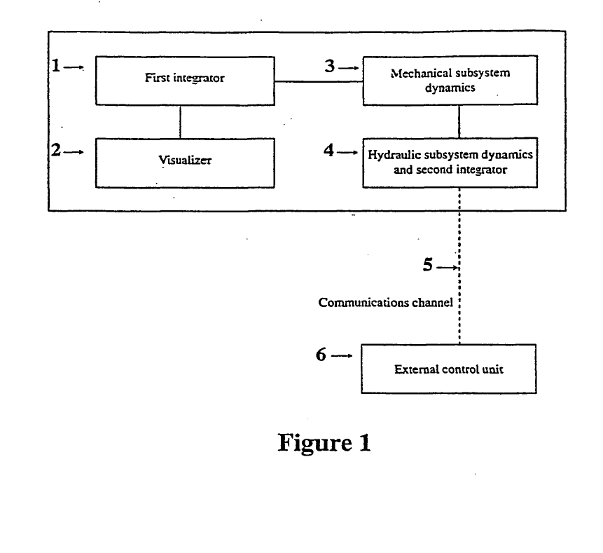

A block diagram of an arrangement according to a preferred embodiment of the invention is shown in FIG. 1. The arrangement consists of a first integrator 1 for computing new states of the system, for example using Equation (8); a visualization module 2 for displaying simulation data; a module 3 for computing mechanical subsystem dynamics, for example using Equation (3); and a module 4 for computing the hydraulics subsystem dynamics and integrating it using a second integrator, for example using Equations (14)-(22). The module corresponding to the hydraulic subsystem and second integrator may be connected through a communications channel 5 to an external control unit 6. The control unit may be a hardware unit or another simulation.

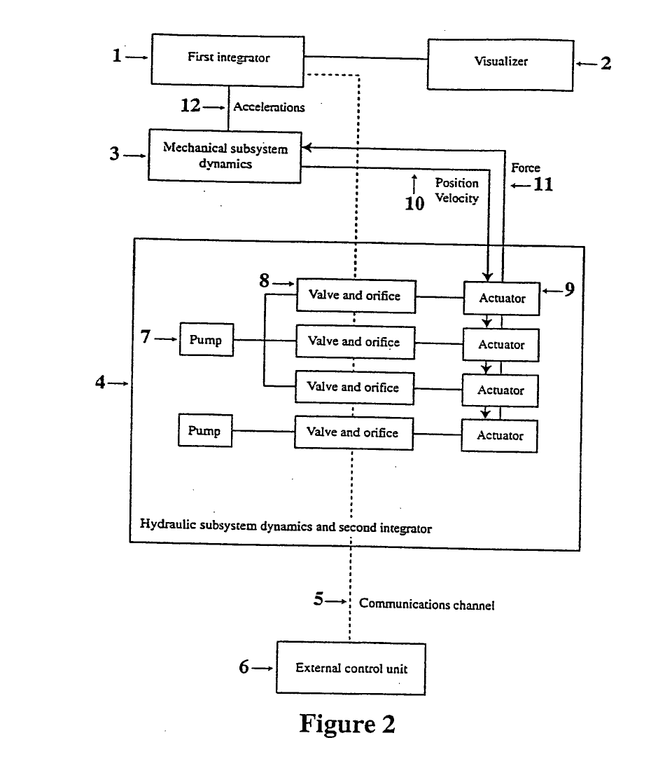

As shown in FIG. 2 the module 4 corresponding to the hydraulic subsystem is typically used to simulate pumps 7, valves and orifices 8, and hydraulic actuators 9. The valve models are in FIG. 2 driven through the communications channel 5 by signals from the external control unit 6. The actuators 9 are connected to the module 3 corresponding to the mechanical system and provide forces 11 as outputs and take position and velocity data 10 as input from the module 3 corresponding to the mechanical subsystem. The module 3 corresponding to the mechanical subsystem provides accelerations 12 to the first integrator 1.

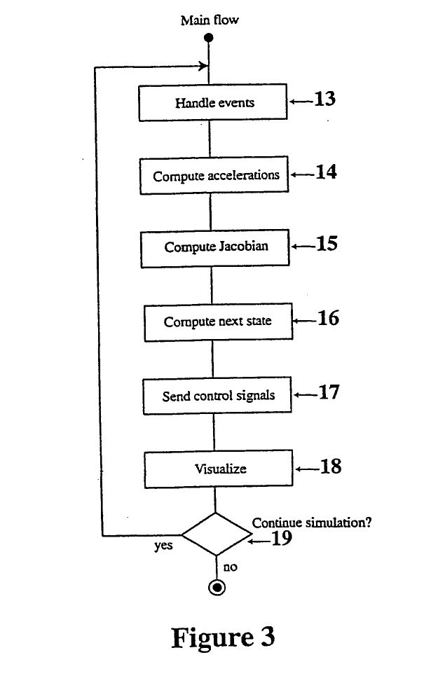

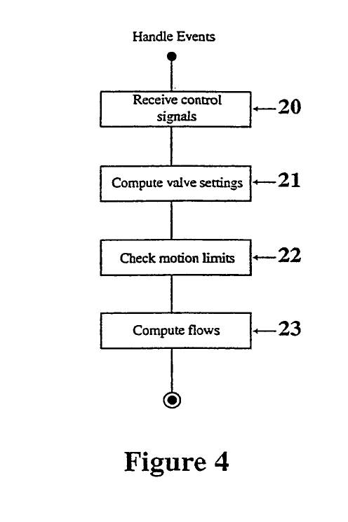

The main flow of control of an arrangement presented in FIGS. 1 and 2 is shown in FIG. 3. Each time step of the simulation consists of the following steps: First events are handled in step 13. This event handling is described in more detail in FIG. 4. Then the accelerations 14 and the Jacobian 15 of the system are used to compute the next state 16 of the system. Typically, based on the new state the first integrator sends information about the system, for example position, velocity, acceleration, pressure or flow information back to the control unit in step 17. User selected quantities and the virtual environment are typically visualized in step 18. In step 19 it is checked if the simulation should continue, if so, the process is repeated from step 13, otherwise the program exits.

The event handling is shown in FIG. 4. First, in step 20, control signals are received from the control unit 6. The signals are used to compute valve settings 21 for the duration of the time step. Next motion limits are checked in step 22, and finally orifice flows are computed in step 23, for example using Equations (20)-(22).

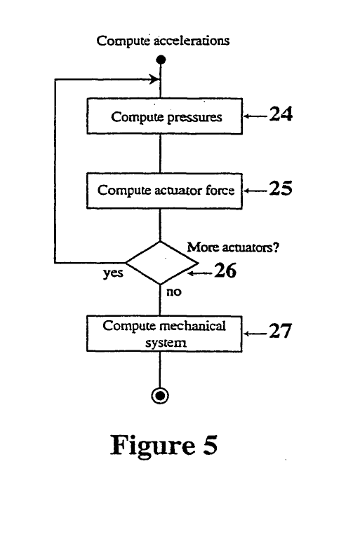

FIG. 5 illustrates computing of accelerations. Typically, for each actuator the pressures in each chamber of the actuator are computed in step 24 by using, for example, Equations (14)-(16) and (22). The force exerted by the actuator is computed in step 25, for example using Equation (17). Typically, the process is repeated 26 until all actuators have been handled. The forces from the actuators and motion limits, see Equation (19), are used to compute the accelerations for the mechanical subsystem in step 27.

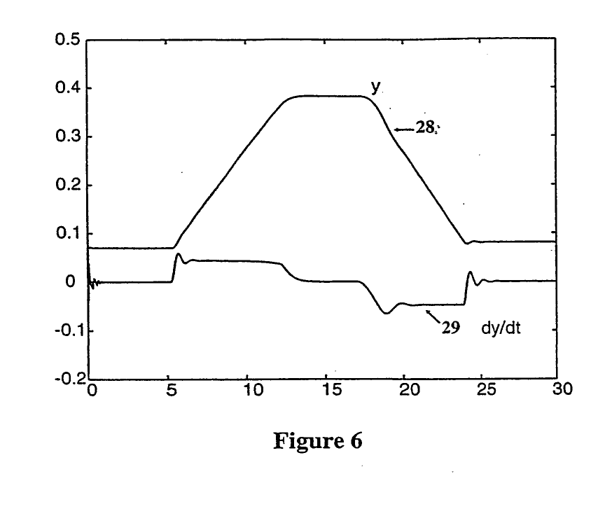

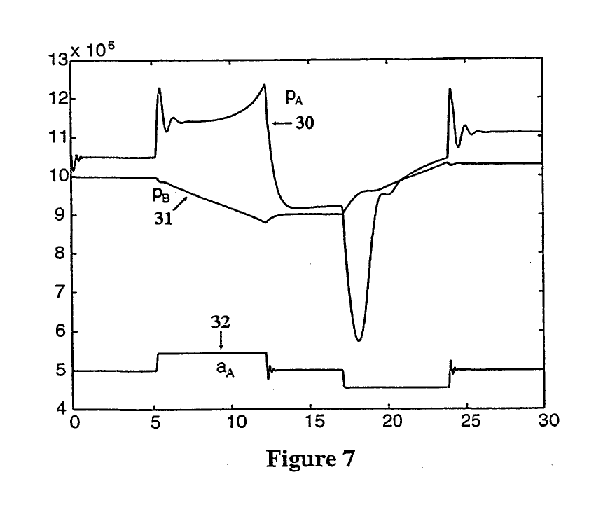

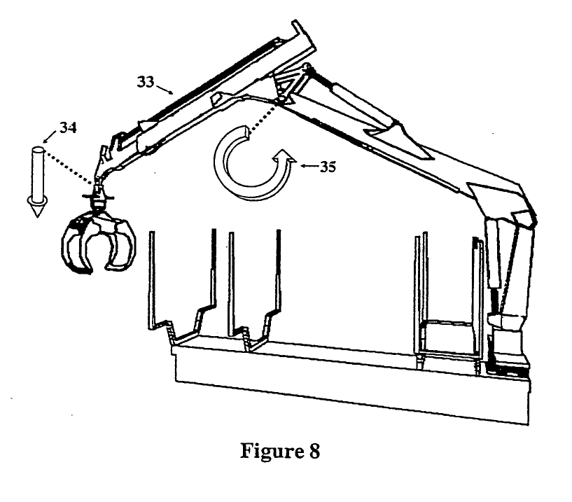

The visualizer module 2 can display user selected quantities, such as positions 28 and velocities 29, as shown in FIG. 6, or quantities related to the hydraulic systems, such as pressures in different chambers of an actuator, 30, 31, and valve orifice parameters 32, as shown in FIG. 7. FIG. 8 shows that the visualizer can additionally or alternatively display the mechanical system in a three dimensional virtual environment 33. This display may also show joint forces 34 and torques 35 as different kinds of arrows, as FIG. 8 illustrates.

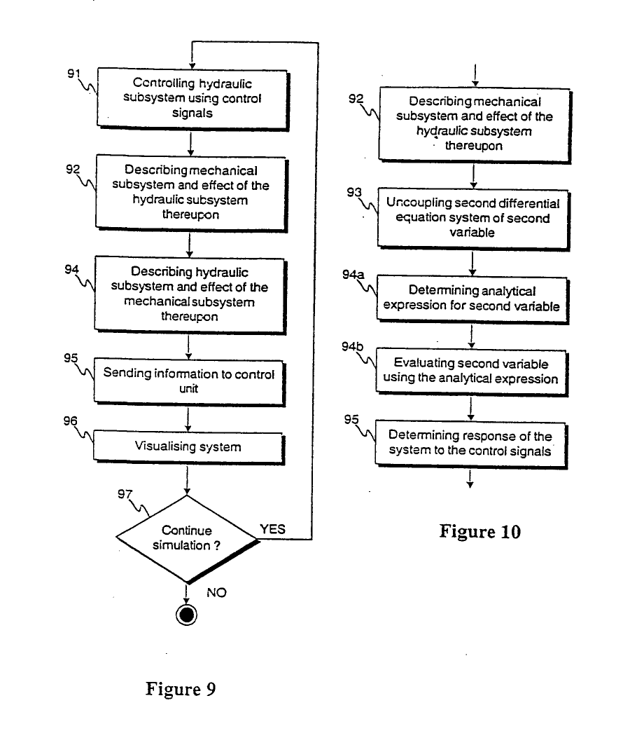

Control signals for the actuator valves are obtained, for example, from an external control unit 6 (which may be either physical hardware or a simulation of the unit running in parallel with the mechanics and hydraulics simulation). The control unit may be, for example, a control unit of an existing hydraulically driven machine. The simulation arrangement can be used, for example, in designing and/or testing control logic of the control unit 6. In testing the control logic it is usually important that the simulation is real-time, so that the response of the machine to the control signals can be determined properly. Furthermore, usually the behavior of the simulated system (machine) is visualized. The control unit signals are typically mapped to the relative valve opening a, see for example Equation (8). Depending on the design of the control unit, any or all of the following quantities, for example, may be sent back to the unit from the simulation: position, velocity, and acceleration data about the mechanical subsystem; pressures and flow rates from the hydraulic subsystem (see step 17 in FIG. 3 or step 95 in FIG. 9). The connection to the control unit is through some communications channel, such as a TCP/IP connection.

The Equations are mentioned in the preceding paragraphs, which describe an arrangement in accordance with the invention, as examples. A simulation arrangement or simulation software according to the invention may employ any method in accordance with the invention, for example one of those described in the accompanying method claims.

FIG. 9 illustrates a flowchart of a method 90 for simulating a system having a mechanical subsystem and a hydraulic subsystem, said method 90 being a method according to a further preferred embodiment of the invention. In step 91 the hydraulic subsystem is controlled using control signals. In step 92 the mechanical subsystem and the effect of the hydraulic subsystem thereupon is described by integrating a first differential equation system of an n-dimensional first variable using a first numerical method, resulting in a sequence of values for said first variable, and in step 94 the hydraulic subsystem and the effect of the mechanical subsystem thereupon is described by integrating a second differential equation system of an m-dimensional second variable using a second numerical method, resulting in a sequence of values for said second variable. Method 90 further comprises step 95, where information relating to or based on at least some values belonging to one of said sequences of values (said information being, for example, position, velocity, acceleration, pressure or flow information) is sent to a control unit. Furthermore, the system is visualized in step 96, said visualizing being based on at least some values belonging to one of said sequences of values. In step 97 it is checked, if the simulation of the system continues.

FIG. 10 illustrates a part of a second method according to an even further preferred embodiment of the invention. This second method further comprises a step 93 of uncoupling differential equations forming said second differential equation system from each other, said uncoupling resulting in uncoupled differential equation, and a step 94a of determining analytical expressions for said uncoupled differential equations using a numerical integration method, for example an implicit method. This results in an analytical expression for said second variable, and in step 94b the second variable is evaluated using said analytical expression.

In addition, the control flows presented in FIGS. 3-5 present a method according to a further embodiment of the invention.

K. Benchmark Results

Simple tests were run with a test mechanism with from 1 to 8 cylinders. The results below are obtained using a simulation employing Equations (8) and (14)-(22). The mechanical systems are uncoupled. The time steps used were h₁=h₂=20 ms.

In the table ‘m’ is the number of cylinders (and masses), ‘time’ is the total time spent in simulating the whole system for one time step of length 20 ms. The computer was a PC with a Pentium III processor running at 500 MHz. Note that the simulation is clearly fast enough for real-time simulation.

| | Time |
|---|---|
| m | (ms) |
| 1 | 0.323 |
| 2 | 0.444 |
| 3 | 0.647 |
| 4 | 0.822 |
| 5 | 1.163 |
| 6 | 1.493 |
| 7 | 1.854 |
| 8 | 2.273 |

A more realistic test covered a model of a forestry machine crane. The crane consists of four links, and each one has a hydraulic actuator driving it (see FIG. 8). Again the simulation step length was 20 ms, this time the computer had a Pentium III processor at 550 MHz. The dynamics of the mechanical system was implemented with an unoptimized implementation of the Featherstone algorithm., The total time required for one integration step was 10.1 ms, which is again clearly sufficient for real-time operation with this time step. Furthermore, it is possible to reduce the running time even more by optimizing the implementation of the Featherstone algorithm.

### L. REFERENCES

[1] V. I. Arnold, Mathematical Methods of Classical Mechanics, Springer 1989.

[2] U. M. Ascher, L. R. Petzold, Computer Methods for Ordinal Differential Equations and Differential-Algebraic Equations, SIAM 1998.

[3] A. Ellman, R. Piché, A Modified Orifice Flow Formula for Numerical Simulation, ASME Int. Mech. Eng. Congr. Exp., 1996.

[4] R. Featherstone, Robot Dynamics Algorithms, Kluwer 1987.

[5] Y. Gonthier, E. Papadopoulos, On the Development of a Real-time Simulator for an Electro-Hydraulic Forestry Machine, Proc. IEEE Int. Conf. Robotics & Automation, 1998.

[6] E. J. Haug, Computer-aided Kinematics and Dynamics of Mechanical Systems, Allyn & Bacon 1989.

[7] E. Hairer, G. Wanner, Solving Ordinary Differential Equations II: Stiff and Differential-algebraic Problems, Springer 1996.

[8] M. Krishna, S. V. Lunzman, Simulation modeling of non-linear hydraulic actuator response, U.S. Pat. No. 5,953,977, 1998.

[9] Z. D. Li, P. I. Corke, H. Z. Gurgenci, Modelling and simulation of an electro-hydraulic mining manipulator, Proc. IEEE Int. Conf. Robotics & Automation, 1997.

[10] Ch. Lubich, M. Roche, Rosenbrock methods for differential-algebraic systems with solution-dependent singular matrix multiplying the derivative Computing 43, 325-342, 1990.

[11] J. Mäkinen, A. Ellman, R. Piché, Dynamic simulations of flexible hydraulic-driven multibody systems using finite strain beam theory, Fifth Scandinavian hit. Conf. Fluid Power, 1997.

[12] E. Papadopoulos, S. Sarkar, On the dynamic modeling of an articulated electrohydraulic forestry machine, Proc. AIAA Forum on Advanced Developments in Space Robotics, 1996.

[13] R. Piché, A. Ellman, M. Vilenius, Integration of numerically stiff fluid power circuit models using L-stable Runge-Kutta methods, Bath Intl. Fluid Power Workshop, 1994.

[14] R. von Schwerin, Multibody System Simulation, Springer 1999.

[15] T. Steihaug, A. Wolfbrandt, An attempt to avoid exact Jacobian and nonlinear equations in the numerical solution of stiff differential equations, Math; Comp., 33 (1979), 521-534.

1. A method (90) for simulating a system having a mechanical subsystem and a hydraulic subsystem, said mechanical subsystem having a number of bodies and said hydraulic subsystem having a number of hydraulic actuators with hydraulic cylinders, said number of bodies being at least one and said number of hydraulic actuators being at least one, characterized in that
the mechanical subsystem and the effect of the hydraulic subsystem thereupon is described by a first differential equation system of an n-dimensional first variable, the first variable comprising coordinates defining the configuration of said mechanical subsystem and the effect of the hydraulic subsystem on the mechanical subsystem being taken into account using actuator forces,
the hydraulic subsystem and the effect of the mechanical subsystem thereupon is described by a second differential equation system of an nm-dimensional second variable, the second variable relating to pressures in said hydraulic cylinders,
the first differential equation system is discretized using a first numerical integration method,
the second differential equation system is discretized using a second numerical integration method,
and in that for each time step of the simulation, after an initialization step, the method comprises the following steps, performed by means of a computer:
determining a current value for the second variable using the discretization of the second differential equation system, a previous value for the first variable and a previous value for the second variable, said previous values having been determined in a previous time step,
computing current actuator forces using at least the current value of the second variable, and
determining a current value for the first variable using the discretization of the first differential equation system, the current actuator forces and the previous value for the first variable.

2. A method according to claim 1, wherein
the hydraulic cylinders are coupled to a number of tanks and to a number of pumps with a number of control valves and flows relating to the control valves are calculated using a predefined flow formula,
the second differential equation system is uncoupled (93) by taking into account the interactions within the hydraulic subsystem using discrete event simulation, and
analytical expression for the discretization of the second differential equation system is determined (94a) using a predefined differential equation for the pressure in a chamber of a hydraulic cylinder and the flow corresponding to said hydraulic cylinder,
and wherein the step of determining a current value for the second variable comprises the substeps of:
calculating (23) current flows relating to the control valves by evaluating the predefined flow formula, and
evaluating (94b, 24) the current value for the second variable using the analytical expression and the current flows,
and wherein the step of computing current actuator forces comprises the substep of:
computing current cylinder forces, which form part of the actuator forces, by evaluating a predefined cylinder force formula and the current value for the second variable.

3. A method according to claim 2, wherein the predefined flow formula takes as inputs for a control valve in a hydraulic cylinder at least previously determined pressure in said hydraulic cylinder and information about previous value for the first variable,

4. A method according to claim 2 or 3, wherein a set of the hydraulic cylinders of said hydraulic subsystem are connected to a single pump and the step of determining a current value for the second variable comprises the substep of:
modifying (23) said flows relating to said set of hydraulic cylinders to take into account the couplings within the hydraulic subsystem and the capacity of the pump.

5. A method according to claim 4, wherein said flows are modified so that the ratio of the modified flows remains the same as the ratio of the unmodified flows and the sum of the modified flows is equal to a source flow produced by said pump.

6. A method according to claim 4, wherein said flows are modified so that a number of largest flows, the sum of said largest flows being less than or equal to a source flow produced by said pump and the number of largest flows being as large as possible, remains unmodified and modified flows corresponding to unmodified flows not belonging to said number of largest flows are zero flows.

7. A method according to claim 4, wherein said flows are modified so that according to a preference order said flows are retained as long as the sum of said retained flows is less than or equal to a source flow produced by said pump.

8. A method according to claim 4, wherein said flows are modified by using predetermined information about the flows in said set of hydraulic cylinders given certain positions for said control valves.

9. A method according to any of the claims 2 to 8, wherein the step of computing current actuator forces comprises the substep of:
calculating motion limiting forces and adding the calculated motion limiting forces to the cylinder forces.

10. A method according to any of the preceding claims, wherein the first differential equation system is a second order differential equation system and the step of determining current value for the first variable comprises a substep of:
calculating current numerical value for the acceleration of the first variable using said current actuator forces.

11. A method according to claim 10, wherein
the second order first differential equation system is modified into a first order differential equation system by replacing the n-dimensional first variable with a 2n-dimensional third variable containing the first variable and the first derivative of the first variable,
and the step of determining current value for the first variable comprises a substep of:
evaluating Jacobian relating to said first order differential equation system, and
calculating a current value for the third variable using said Jacobian and said current numerical value for the acceleration of the first variable.

12. A method according to claim 11, wherein the Jacobian is evaluated using divided differences.

13. A method according to claim 11 or claim 12, wherein the numerical value for the acceleration of the first variable is calculated using the Featherstone algorithm.

14. A method according to claim 11 or claim 12, wherein the numerical value for the acceleration of the first variable is derived from equations describing explicitly said mechanical subsystem.

15. A method according to any of the preceding claims, wherein the second numerical method is different from the first numerical method.

16. A method according to claim 15, wherein the first numerical method is a semi-implicit method for numerical integration and the second numerical method is an implicit method for numerical integration.

17. A method according to claim 15, wherein the first numerical method is a semi-implicit numerical method and the second numerical method is a semi-implicit method for numerical integration.

18. A method according to claim 15, wherein the first numerical method is an implicit method for numerical integration and the second numerical method is an implicit method for numerical integration.

19. A method according to claim 15, wherein the first numerical method is an implicit numerical method and the second numerical method is a semi-implicit method for numerical integration.

20. A method according to any of the preceding claims, wherein a second time step, which is shorter than the time step for the simulation, is used for determining intermediate values for the second variable in the step of determining the current value for the second variable, and wherein the time step for simulation is used in determining the current value for the first variable.

21. A method according to any of the preceding claims, further comprising a step of:
visualizing (18, 96) the behavior of said system during simulation.

22. A method according to any of the preceding claims, further comprising a step of:
controlling (91) said hydraulic subsystem using control signals.

23. A method according to claim 22, wherein the control signals are obtained from a separate control unit and the method further comprising a step of:
sending (95) information relating to current value of at least one of said first and second variables to said separate control unit for at least part of the simulation time steps.

24. A method according to claim 22 or 23, wherein the hydraulic cylinders of the hydraulic subsystem are connected to a number of tanks and to a number of pumps with a number of control valves and the control signals are controlling (17, 20, 21) the relative openings of said control valves.

25. A computer program for simulating a system having a mechanical subsystem and a hydraulic subsystem, said mechanical subsystem having a number of bodies and said hydraulic subsystem having a number of hydraulic actuators with hydraulic cylinders, said number of bodies being at least one and said number of hydraulic actuators being at least one, characterized in that said computer program comprises computer program code means adapted to perform, for each time step of the simulation after an initialization step, the following steps when the program is run on a computer:
determining a current value for a second variable using a discretization of a second differential equation system, a previous value for the second variable and a previous value for a first variable, where the second differential equation system of the m-dimensional second variable, which relates to pressures in said hydraulic cylinders, describes the hydraulic subsystem and the effect of the mechanical subsystem thereupon, the second differential equation system is being discretized using a second numerical integration method and said previous values of the first and second variables have been determined in a previous time step,
computing current actuator forces using at least the current value of the second variable, and
determining a current value for the first variable using a discretization of a first differential equation system, the current actuator forces and the previous value for the first variable, where the first differential equation system of the n-dimensional first variable, which comprises coordinates defining the configuration of said mechanical subsystem, describes the mechanical subsystem and the effect of the hydraulic subsystem thereupon, the effect of the hydraulic subsystem on the mechanical subsystem is being taken into account using the actuator forces, and the first differential equation system is being discretized using a first numerical integration method.

26. A computer program as claimed in claim 25 embodied on a computer readable medium.

27. A simulation arrangement for simulating a system having a mechanical subsystem and a hydraulic subsystem, said mechanical subsystem having a number of bodies and said hydraulic subsystem having a number of hydraulic actuators with hydraulic cylinders, said number of bodies being at least one and said number of hydraulic actuators being at least one, characterized in that it comprises
means (4) for determining a current value for a second variable using a discretization of a second differential equation system, a previous value for the second variable and a previous value for a first variable, where the second differential equation system of the nm-dimensional second variable, which relates to pressures in said hydraulic cylinders, describes the hydraulic subsystem and the effect of the mechanical subsystem thereupon, the second differential equation system is being discretized using a second numerical integration method and said previous values of the first and second variables have been determined in a previous time step,
means for computing current actuator forces using at least the current value of the second variable, and
means (1, 3) for determining a current value for the first variable using a discretization of a first differential equation system, the current actuator forces and the previous value for the first variable, where the first differential equation system of the n-dimensional first variable, which comprises coordinates defining the configuration of said mechanical subsystem, describes the mechanical subsystem and the effect of the hydraulic subsystem thereupon, the effect of the hydraulic subsystem on the mechanical subsystem is being taken into account using actuator forces, and the first differential equation system is being discretized using a first numerical integration method,
and in that said means for determining the current value for the second variable, said means for computing the current actuator forces the and said means for determining the current value for the first variable are adapted to be active for each time step of the simulation after an initialization step.

28. An arrangement according to claim 27, further comprising
means (2) for visualizing behavior of said system.

29. An arrangement according to claim 27 or 28, further comprising
means (6) for controlling said system using control signals, and
means (5) for communicating said control signals to said means (4) for determining the current value for the second variable,
and wherein said means (4) for determining the current value for the second variable comprise means for mapping said control signals to openings of control valves belonging to said hydraulic part.

30. An arrangement according to claim 29, wherein said means (6) for controlling said system is a computer program.

31. An arrangement according to claim 29, wherein said means (6) for controlling said system is a control unit for controlling a physical device, the control unit being connected to other means forming said arrangement.

32. An arrangement according to claim 31, wherein said other means forming said arrangement are realized as a set of computer programs.

33. An arrangement according to any one of claims 27 to 32, wherein at least one of said means (1, 3) for determining the current value for the first variable and said means (4) for determining the current value for the second variable is arranged to send information relating to the current value of at least one of said first and second variable for at least part of the simulation time steps to said means (6) for controlling said system.

34. An arrangement according to any one of claims 27 to 33, wherein said arrangement is realized as a set of computer programs.
